(19) United States
(12) Patent Application Publication
(10) Pub. No.: US 2004/0200219 A1
(43) Pub. Date: Oct. 14, 2004

(54) Braking device using an integrated master-cylinder brake booster

(76) Inventor: Jean-Marc Attard, Chantilly (FR)

Correspondence Address: Leo H McCormick, PO Box 4721, 2112 Mishawaka Avenue, South Bend, IN, 46634-4721, US

(21) Appl. No.: 10/487,150

(22) PCT Filed: Jul. 30, 2002
(86) PCT No.: PCT/FR02/02732

(30) Foreign Application Priority Data
Aug. 8, 2001 (FR) 01/10620

(51) Int. Cl. B60T 13/00

(52) U.S. Cl. 60/547.1

(57) ABSTRACT

The invention relates to a braking device, which mainly comprises a pneumatic servomotor (1) and a master cylinder (2), the servomotor comprising in particular a rigid casing (10), a moving partition wall (11), front and rear chambers (101, 102), and a pneumatic piston (12), and the master cylinder (2) comprising more particularly primary and secondary pistons (221, 222) defining primary and secondary pressure chambers (241, 242), and an actuating rod (23) which controls the primary piston (221).

The master cylinder (2) is integral with the pneumatic piston (12) and slidingly fitted inside the front chamber (101), whereas the actuating rod (23) is hollow, integral with the rigid casing (10) and communicates with the primary pressure chamber (241), the secondary piston (222) is traversed, in an airtight manner, by a passage (25) communicating with the secondary chamber (242), and extending through the primary chamber (241) and the actuating rod (23), while being stationary in relation to the rigid casing (10).

This invention relates generally to the technical field of braking systems for motor vehicles.

More particularly, the present invention deals with a braking device, comprising a pneumatic servomotor for an assisted braking and a master cylinder, the servomotor comprising: a rigid casing; a moving partition wall, dividing the rigid casing into a front chamber and a rear chamber, selectively under one and the same first pressure, or respectively under the first pressure and under a second pressure, which is higher than the first one; a pneumatic piston, travelling with the moving partition wall; a plunger accommodated inside the pneumatic piston and selectively driven by a control rod, which is movable relative to the pneumatic piston, under the action of a return force and of an actuation counterforce, between a rest position and a maximum actuation position; a three-way valve, controlled by the position of the control rod and controlling the pressure inside the rear chamber; and a reaction means for applying, to the plunger, a reaction force dependent on the actuation force, and wherein the master cylinder comprises: an elongate body provided with a longitudinal bore having an opening and an end wall primary and secondary coaxial pistons, each of them being slidably fitted in the bore in an airtight manner, between a rest position and a maximum actuation position, wherein the primary piston is integral with an actuating rod passing through the opening of the bore; a primary pressure chamber, defined between the primary and secondary pistons; and a secondary pressure chamber, defined between the secondary piston and the end wall of the bore.

Though such devices are well known and have been used successfully for decades, they are still the subject of quite a number of extensive researches, with a view to the optimization of their qualities.

Therefore, it is the object of the present invention, which fits wholly into both this background and this trend, to provide a braking device having, while ensuring an equal or even higher performance, much smaller dimensions then the known devices of the same type.

To this end, the device according to the invention, which is consistent with the generic definition as per the introductory part hereinabove, is mainly characterised in that the body of the master cylinder is integral with the pneumatic piston and slidingly fitted inside the front chamber, in that the actuating rod is hollow, integral with the rigid casing and communicates with the primary pressure chamber, and in that the secondary piston is traversed, in an airtight manner, by a passage communicating with the secondary chamber, and extending through the primary chamber and the actuating rod, while being stationary in relation to the rigid casing.

In a preferred manner, the body of the master cylinder is under the second pressure on the side of the opening of the bore.

The end wall of the bore exhibits, e.g., a hole which constitutes the reaction means and in which the plunger is slidingly fitted in an airtight manner, with the result that the reaction force, applied to the plunger, is proportional to the pressure prevailing inside the secondary chamber.

In a preferred manner, at least a first longitudinal section of the body of the master cylinder is surrounded in an airtight manner with a coupling sleeve, a first end of which is disposed inside the front chamber and a second end of which is under the second pressure.

In that case, the body of the master cylinder may be arranged to comprise a resupply passage, which is connected with the primary and secondary chambers for the rest position of the primary and secondary pistons. And the resupply passage may mouth through a connecting port into the first longitudinal section of the body, and outside such body, and the coupling sleeve may communicate with a hydraulic-fluid tank.

Most advantageously, the tank itself may be accommodated in the front chamber and made in a single piece with the tight coupling sleeve.

In the same way, the pneumatic piston and the body of the master cylinder may be manufactured in a single piece.

In a manner known per se, the primary and secondary pistons may be fitted for an airtight sliding motion inside the bore by means of seals, which are stationary relative to the body.

Besides, when the pneumatic piston is mounted for an airtight sliding motion inside the rigid casing, by an end having a first cross-sectional area subjected to the second pressure, and when the second end of the coupling sleeve, under the second pressure, exhibits a second cross-sectional area, then the second cross-sectional area should be greater than the first cross-sectional area.

In that case, the front chamber of the servomotor may be free from a return spring.

Other features and advantages of the present invention will be apparent from the following detailed description, by way of example and by no means as a limitation, when taken in conjunction with the accompanying drawings, in which:

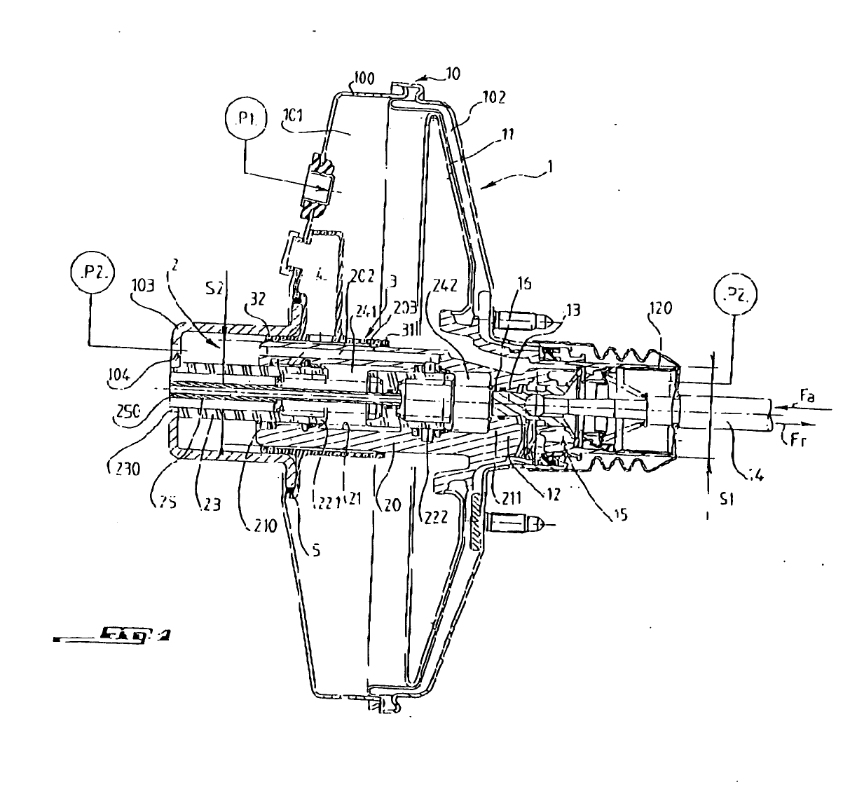

FIG 1. is an overall sectional view of a device according to the invention, shown in the rest position; and

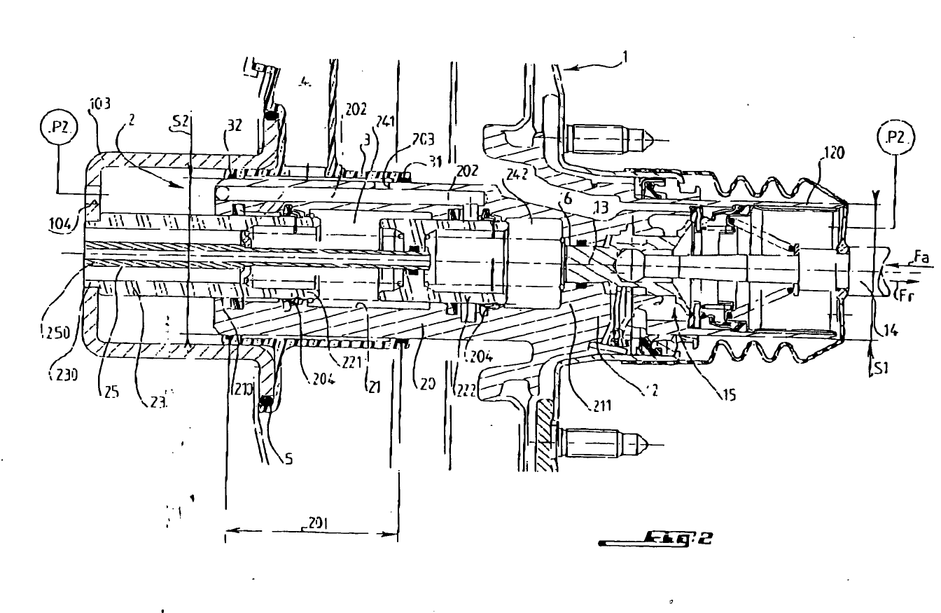

FIG. 2 is an enlarged sectional view of a detail of the device shown in FIG. 1.

As set out hereinbefore, the invention relates to a braking device comprising a pneumatic servomotor 1 for an assisted braking and a master cylinder 2.

In a well-known manner, the servomotor 1 mainly comprises a rigid casing 10, a moving partition wall 11, a pneumatic piston 12, a plunger 13, a control rod 14, a valve 15 and a reaction means 16.

The moving partition wall 11 divides the rigid casing 10 into a front chamber 101 and a rear chamber 102, the front chamber 101 being permanently, in the operational conditions of the device, under a relatively low pressure P1, for instance a negative pressure created in the inlet manifold of a thermal engine or by a vacuum pump.

When the servomotor 1 is at rest (cf. Fig.), the rear chamber 102 is under the same relatively low pressure P1.

When the servomotor is actuated, the rear chamber 102 is connected to a pressure source delivering a higher pressure, for instance the atmospheric pressure, with the result that the rear chamber 102 is subjected to a pressure P2, which is higher than the pressure P1, and the pressure difference between the chambers 101 and 102 draws up the moving partition wall 11 towards the front chamber 101, together with the piston 12 travelling with said partition wall.

The plunger 13 is accommodated in the pneumatic piston 12 and it takes a position as controlled by the control rod 14, which is movable in relation to the pneumatic piston 12.

Therefore, the plunger 13 and the control rod 14 are capable of moving between a rest position, shown in the Fig., and a maximum actuation position, under the action of a return force Fr, bringing them back to the rest position, and an actuation counterforce Fa, exerted by the driver when applying the brakes.

The three-way valve 15 is controlled through the position of the control rod 14 and its function consists in controlling the pressure prevailing inside the rear chamber 102, in that it connects the rear chamber 102 either with the front chamber 101 or to the pressure P2, in this case the atmospheric pressure.

As regards the reaction means 16, it is designed to apply, to the plunger 13, a reaction force dependent on the actuation force Fa exerted by the driver.

On the other hand, the master cylinder 2 comprises an elongate body 20, primary and secondary pistons 221 and 222, an actuating rod 23, and primary and secondary pressure chambers 241 and 242.

The body 20 of the master cylinder 2 is provided with a longitudinal bore 21, having an opening 210 and an end wall 211.

The primary and secondary pistons 221 and 222 are coaxial, and each of them is slidably fitted in the bore 21 in an airtight manner, between a rest position and a maximum actuation position.

These pistons 221 and 222 are, e.g., mounted for an airtight sliding motion inside the bore 21, by means of seals 204, which are stationary relative to the body 20, in a way known per se.

The actuating rod 23, which is integral with the primary piston 221, passes through the opening 210 of the bore 21 and consequently moves the primary piston 221.

The primary pressure chamber 241 is defined between the primary and secondary pistons 221 and 222, whereas the secondary pressure chamber 242 is defined between the secondary piston 222 and the end wall 211 of the bore 21.

According to a first essential aspect of this invention, the body 20 of the master cylinder 2 is integral with the pneumatic piston 12 and slidingly fitted inside the front chamber 101, relative to the rigid casing 10.

According to a second essential aspect of the invention, the actuating rod 23 is hollow, integral with the rigid casing 10 and communicates, through its inner space, with the primary pressure chamber 241.

For instance, the actuating rod 23 is set in a cup-shaped cover 103 extending through an opening in the front shell 100 of the casing 10 and being an integral part of it.

And, according to a third essential aspect of the present invention, the secondary piston 222 is traversed, in an airtight manner, by a passage 25 communicating with the secondary chamber 242, and extending through the primary chamber 241 and the actuating rod 23, and being stationary in relation to the rigid casing 10.

For instance, such passage 25 may become an integral part of the cover 103 using any appropriate means.

This being so, the mouth 250 of the passage 25 to the outside of the cover 103 constitutes the outlet of the secondary pressure chamber 242, whereas the ring-shaped mouth 230 of the actuating rod 23 to the outside of the cover 103 and around the passage 25 forms the outlet of the primary pressure chamber 241.

The cover 103 is pierced through by a port 104 for the inner space, defined by the cover, to be under the second pressure P2, that is the atmospheric pressure, and such inner space is separated from the front chamber 101 by a ring-type joint 5.

A coupling sleeve 3 is disposed inside the front chamber 101 and fastened to the rigid casing 10, in such a way that its first end 31 is located within the first chamber 101 and therefore under the low pressure P1 prevailing inside the front chamber, whereas its second end 32 is arranged inside the cover 103 and consequently subjected to the atmospheric pressure P2.

The body 20 of the master cylinder 2 is inserted for an tight sliding motion in the coupling sleeve 3, which covers a longitudinal section 201 of it, with the result that the body 20 of the master cylinder 2 is under the atmospheric pressure P2 on the side of the opening 210 of the bore 21 and of the, end 32 of the coupling sleeve.

As shown in the Fig., the pneumatic piston 12 is fitted for an airtight sliding motion inside the rigid casing 10 by an end 120, also called a “piston tail”, which has a cross-sectional area Si, subjected to the atmospheric pressure P2.

Besides, the end 32 of the coupling sleeve 3, under the atmospheric pressure P2 too, exhibits a cross-sectional area S2.

In a preferred manner, the cross-sectional area S2 is greater than the cross-sectional area S1, so that the body 20 of the master cylinder 2 is drawn up towards the inside of the casing 10, i.e. in the right-hand direction in the Fig., owing to the difference between the pressures P1 and P2 and due to the difference between the cross-sectional areas S1 and S2, so much so that the front chamber 101 of the servomotor 1 may be free from a return spring, contrary to the conventional servomotors, which must be provided with a return spring for returning the moving partition wall 11 to its rest position.

The reaction means is, e.g., constituted by a hole 16, made in the end wall 211 of the bore 21 provided in the master cylinder 2, and in which the plunger 13 is slidingly fitted in an airtight manner, with the result that the reaction force, applied to the plunger 13, is proportional to the pressure prevailing inside the secondary chamber 242 of the master cylinder.

The coupling sleeve 3 communicates with a hydraulic-fluid tank 4, which is disposed inside the front chamber 101 and made in a single piece with such coupling sleeve.

Besides, the body 20 of the master cylinder 2 comprises a resupply passage 202, which is caused to communicate with the primary and secondary chambers 241 and 242 for the rest position of the primary and secondary pistons 221 and 222.

Such resupply passage 202 mouths, outside the body 20 of the master cylinder, through a connecting port 203 opening into the longitudinal section 201 of the body 20, that is inside the tight coupling sleeve 3.

Insofar as the coupling sleeve 3 communicates with the tank 4, the hydraulic fluid contained in the tank 4 flows in the coupling sleeve 3, through the connecting port 203 and enters the resupply passage 202 so as to resupply the primary and secondary pressure chambers 241 and 242 quite conventionally.

And last but not least, as illustrated in the Fig., the pneumatic piston 12 and the body 20 of the master cylinder 2 may be made in a single piece, which means the optimisation of the manufacturing process of the device according to this invention.

The device according to the invention offers numerous advantages.

More particularly, if the pneumatic piston is made in one piece with the body of the master cylinder, the resultant monobloc piece achieves the preliminary relative centering of both shells of the rigid casing before their being crimped, and ensures an improved guidance of the pneumatic piston inside the casing 10.

1. A braking device, comprising a pneumatic servomotor (1) for an assisted braking and a master cylinder (2), the servomotor (1) comprising: a rigid casing (10); a moving partition wall (11), dividing the rigid casing (10) into a front chamber (101) and a rear chamber (102), selectively under one and the same first pressure (P1), or respectively under the first pressure (P1) and under a second pressure (P2), which is higher than the first one (P1); a pneumatic piston (12), travelling with the moving partition wall (11); a plunger (13) accommodated inside the pneumatic piston (12) and selectively driven by a control rod (14), which is movable relative to the pneumatic piston (12), under the action of a return force (Fr) and of an actuation counterforce (Fa), between a rest position and a maximum actuation position; a three-way valve (15), controlled by the position of the control rod (14) and controlling the pressure inside the rear chamber (102); and a reaction means (16) for applying, to the plunger (13), a reaction force dependent on the actuation force (Fa), and wherein the master cylinder (2) comprises: an elongate body (20) provided with a longitudinal bore (21) having an opening (210) and an end wall (211); primary and secondary coaxial pistons (221, 222), each of them being slidably fitted in the bore (21) in an airtight manner, between a rest position and a maximum actuation position, wherein the primary piston (221) is integral with an actuating rod (23) passing through the opening (210) of the bore; a primary pressure chamber (241), defined between the primary and secondary pistons (221, 222); and a secondary pressure chamber (242), defined between the secondary piston (222) and the end wall (211) of the bore, characterised in that the body (20) of the master cylinder (2) is integral with the pneumatic piston (12) and slidingly fitted inside the front chamber (101), in that the actuating rod (23) is hollow, integral with the rigid casing (10) and communicates with the primary pressure chamber (241), and in that the secondary piston (222) is traversed, in an airtight manner, by a passage (25) communicating with the secondary chamber (242), and extending through the primary chamber (241) and the actuating rod (23), while being stationary in relation to the rigid casing (10).

2. The braking device according to claim 1, characterised in that the body (20) of the master cylinder (2) is under the second pressure (P2) on the side of the opening (210) of the bore (21).

3. The braking device according to claim 2, characterised in that the end wall (211) of the bore (21), provided in the master cylinder (2), exhibits a hole (16) which constitutes the reaction means and in which the plunger (13) is slidingly fitted in an airtight manner, with the result that the reaction force, applied to the plunger (13), is proportional to the pressure prevailing inside the secondary chamber (242).

4. The braking device according to claim 3, characterised in that at least a first longitudinal section (201) of the body (20) of the master cylinder (2) is surrounded in an airtight manner with a coupling sleeve (3), a first end (31) of which is disposed inside the front chamber (101) and a second end (32) of which is under the second pressure (P2).

5. The braking device according to claim 4, characterised in that the body (20) of the master cylinder (2) comprises a resupply passage (202), which is connected with the primary and secondary chambers (241, 242) for the rest position of the primary and secondary pistons (221, 222), in that the resupply passage (202) mouths, through a connecting port (203), into the first longitudinal section (201) of the body (20), and outside said body, and in that the coupling sleeve (3) communicates with a hydraulic-fluid tank (4).

6. The braking device according to claim 5, characterised in that the tank (4) itself is accommodated in the front chamber (101) and made in a single piece with the tight coupling sleeve (3).

7. The braking device according to claim 5, characterised in that the pneumatic piston (12) and the body (20) of the master cylinder (2) are made in a single piece.

8. The braking device according to claim 5, characterised in that the primary and secondary pistons (221, 222) are fitted for an airtight sliding motion inside the bore (21), by means of seals (204), which are stationary relative to the body (20).

9. The braking device according to claim 8 in combination with claims 2 and 4, characterised in that the pneumatic piston (12) is mounted for an airtight sliding motion inside the rigid casing (10), by an end (120) having a first cross-sectional area (S1) subjected to the second pressure (P2), in that the second end (32) of the coupling sleeve (3), under the second pressure (P2), exhibits a second cross-sectional area (S2), and in that the second cross-sectional area (S2) is greater than the first cross-sectional area (S1).

10. The braking device according to claim 9, characterised in that the front chamber (101) of the servomotor (1) is free from a return spring.
